(19) United States
(12) Patent Application Publication
(10) Pub. No.: US 2026/0321011 A1
(43) Pub. Date: Oct. 15, 2026

(54) METHOD FOR MONITORING GUEST USAGE STATUS BY USING AT LEAST ONE CAMERA, AND DEVICE SUPPORTING SAME

(71) Applicant: HANWHA VISION CO., LTD., Seongnam-si (KR)

(72) Inventors: Younghun LEE, Seongnam-si (KR); Dohyun KIM, Seongnam-si (KR); Seokyong YOON, Seongnam-si (KR)

(73) Assignee: HANWHA VISION CO., LTD., Seongnam-si (KR)

(21) Appl. No.: 19/055,466

(22) PCT Filed: Aug. 16, 2023
(86) PCT No.: PCT/KR2023/012077

§ 371 Date: Feb. 17, 2025

(30) Foreign Application Priority Data
Aug. 16, 2022 (KR) 10-2022-0101767

(51) Int. Cl. G06V 20/52; G06Q 10/02; G06Q 50/12; G06V 10/74; G06V 20/62; G06V 40/10

(52) U.S. Cl. CPC G06V 20/52; G06Q 10/02; G06Q 50/12; G06V 10/761; G06V 20/625; G06V 40/10; G06V 2201/08

(57) ABSTRACT

The present disclosure provides a method for monitoring a guest usage status through at least one camera. The method includes performing check-in for a customer scheduled to stay, based on vehicle license plate information acquired by a first camera, confirming types of guests entering a guest room through guest information of the guest which is acquired by a second camera and re-identification (Re-ID) of the guest which is acquired by a third camera, based on the guest information, and tracking a movement path of a specific guest through image information of the specific guest coming out of the guest room which is acquired by the third camera and the re-identification of the specific guest which is acquired by a fourth camera, based on the image information of the specific guest.

### TECHNICAL FIELD

The present disclosure relates to a method for monitoring a guest usage status, and more specifically, relates to a method for monitoring a guest usage status by using at least one camera and an apparatus for supporting the method.

### BACKGROUND ART

A method for guests to check in at existing accommodation facilities is largely classified into three ways. In a first method, a lobby manager directly meets a guest, searches reservation information in a system by using a reservation number or a reservation name, and provides a physical key. However, the first method has a disadvantage in that fixed labor costs are required and the guest needs to wait for check-in for a very long time. In a second method, the guest directly receives the physical key at an unmanned kiosk in a lobby. Although the second method has an advantageous effect of reducing the fixed labor costs, the guest still waits for the check-in for a while due to a limited number of kiosk devices. In addition, according to this method, an elderly guest who has difficulty in using the kiosk is unlikely to check in at the accommodation facilities, and physical defects in low-priced kiosks may result in strong customer complaints.

In a third method, the guest confirms in at the accommodation facilities by using a mobile key. This method has fewer disadvantages of the fixed labor costs and malfunctions caused by the low-priced kiosks. However, it takes time for the guest to install and set up a check-in mobile application in the lobby for mobile key check-in. Consequently, the guest may have difficulty in quick check-in.

In the existing methods described above, it is difficult to identify types of customers visiting the accommodation facilities such as hotel, due to issues such as a waiting time, and it is impossible to track what type of facilities the customers mainly use when the customers actually stay in the accommodation facilities. Consequently, when target marketing is less likely to be promoted depending on a customer type, advantageous effects of the existing methods cannot be measured.

In addition, in an industry of the accommodation facilities traditionally maintained by high fixed labor costs, the industry pursues reduction in the fixed costs by using non-face-to-face check-in, but wishes to maintain service quality for guests.

### DETAILED DESCRIPTION OF INVENTION

### Technical Problems

Therefore, the present disclosure aims to provide a method for analyzing types of guests and tracking and analyzing a movement of the guests camera group image information acquired by multiple cameras.

Technical aspects to be achieved in the present disclosure are not limited to technical aspects described above, and other technical aspects not described herein can be clearly understood by a person having ordinary skill in the art to which the present disclosure belongs, from the description below.

### Technical Solution

According to the present disclosure, there is provided a method for monitoring a guest usage status by using at least one camera. The method includes a step of performing check-in for a customer scheduled to stay, based on vehicle license plate information acquired by a first camera, a step of confirming types of guests entering a guest room by using guest information of the guest which is acquired by a second camera and re-identification (Re-ID) of the guest which is acquired by a third camera, based on the guest information, and a step of tracking a movement path of a specific guest by using image information of the specific guest coming out of the guest room which is acquired by the third camera and the re-identification of the specific guest which is acquired by a fourth camera, based on the image information of the specific guest.

In addition, the method for monitoring the guest usage status may further include a step of analyzing the confirmed type of the guest and the tracked movement path of the specific guest, and a step of generating accommodation history information of the guest, based on a result of the analysis.

In addition, in the present disclosure, the customer scheduled to stay may be a guest making a reservation by using a management system for managing guests in advance, and the guest may be a guest who completes check-in for the guest room.

In addition, in the present disclosure, the guest information may include information of the checked-in guests staying in the guest room and the guest room′ number, and the information of the checked-in guests may include a count of the checked-in guests staying in the guest room and image information of the checked-in guests staying in the guest room.

In addition, in the present disclosure, type of the guests may include at least one of a relationship between the checked-in guests staying in the guest room, a gender of the checked-in guests, and an age group of the checked-in guests.

In addition, in the present disclosure, the relationship between the checked-in guests may be one of friends, family members, and lovers.

In addition, in the present disclosure, the types of the guests may be confirmed when the count of the checked-in guests in the guest room which is included in the guest information and the count of the checked-in guests in the guest room which is acquired by the third camera are identical to each other.

In addition, in the present disclosure, the step of performing the check-in may include a step of comparing the vehicle license plate information acquired by the first camera with the vehicle license plate information registered in advance in the management system, and a step of providing the customer scheduled to stay with mobile check-in or providing the customer scheduled to stay to perform direct check-in in a lobby, based on a result of the comparison.

In addition, in the present disclosure, the first camera may be installed in a parking lot of a hotel, the second camera may be installed in a lobby of the hotel, the third camera may be installed in a guest room corridor of the hotel, and the fourth camera is installed in a communal space of the hotel.

In addition, according to the present disclosure, there is provided a server for monitoring a guest usage status by using at least one camera. The server includes a wireless communicator for transmitting and receiving wireless signals, a memory, and a controller functionally connected the wireless communicator and the memory. The controller performs check-in for a customer scheduled to stay, based on vehicle license plate information acquired by a first camera, confirms types of guests entering a guest room by using guest information of the guest which is acquired by a second camera and the re-identification (Re-ID) of the guest which is acquired by a third camera, based on the guest information, and controls cameras to track a movement path of the specific guest by using image information of the specific guest coming out of the guest room which is acquired by the third camera and the re-identification of the specific guest which is acquired by a fourth camera, based on the image information of the specific guest.

### Effect Of Invention

The present disclosure can provide an efficient accommodation experience for guests and accommodation facility operators in an accommodation industry such as hotels.

In addition, according to the method provided in the present disclosure, the guests can quickly check in at the accommodation facilities by using mobile phones of the guests instead of waiting a long time at a designated check-in time in existing lobbies. Therefore, there is an advantageous effect in that the guests can complete the check-in and can immediately enter guest rooms without deliberately moving to the lobbies and waiting for the check-in.

In addition, according to the method provided in the present disclosure, the accommodation facility operators can identify types of customers even in a non-face-to-face situation where the guests enter the guest rooms without check-in procedures at the lobbies. Therefore, there is an advantageous effect in that the identified types of the customers can be effectively used for future marketing.

In addition, according to the method provided in the present disclosure, the accommodation facility operators can analyze preferences of the corresponding types of the guests in more detail by checking which internal facilities are mainly used by the guests inside the accommodation facilities such as hotels. Therefore, there is an advantageous effect in that results of the analysis can be utilized to predict facility operations and to develop future facilities.

In addition, according to the method provided in the present disclosure, the accommodation facilities can recognize the exact count of guests who enter the guest rooms, and can minimize operational losses caused by more guests than checked-in guests whose information is shared in advance. Therefore, there is an advantageous effect in that the accommodation facilities can charge for additional guests.

In addition, according to the method provided in the present disclosure, the accommodation facilities can receive notifications of behaviors such as falling down or late-night wandering of guests requiring a special care, such as elder persons and disabled persons. Therefore, there is an advantageous effect in that the accommodation facilities can effectively assist the guests to enjoy safe accommodation.

Advantageous effects that can be obtained from the present disclosure are not limited to the advantageous effects described above, and other advantageous effects that are not described herein will be clearly understood by a person having ordinary skill in the art to which the present disclosure belongs, from the description below.

### BRIEF DESCRIPTION OF THE DRAWING

The accompanying drawings included as a part of the detailed description helps to facilitate understanding of the present disclosure. Together with the detailed description, the accompanying drawings are used to describe technical features of the present disclosure.

FIG. 1 is a diagram illustrating an example of a conceptual diagram of a guest management system to which a method proposed in the present disclosure is applicable.

FIG. 2 is a diagram illustrating an example of multiple cameras proposed in the present disclosure.

FIG. 3 is an internal block diagram illustrating a device to which the method proposed in the present disclosure is applicable.

FIG. 4 is a block diagram of an AI device to which the method proposed in the present disclosure is applicable.

FIG. 5 is a diagram illustrating an example of a re-identification method applicable to the method proposed in the present disclosure.

FIG. 6 is a flowchart illustrating an example of a method for analyzing types of guest and tracking movement paths of the guests by using information of a customer scheduled to stay in a guest management system proposed in the present disclosure.

FIG. 7 is a flowchart illustrating an example of a method for managing the guests which is proposed in the present disclosure.

FIG. 8 is a flowchart illustrating an example of a tracking method applicable to the method proposed in the present disclosure.

FIG. 9 is a flowchart illustrating an example of a method for tracking a person by using a camera which is proposed in the present disclosure.

### BEST MODE FOR CARRYING OUT THE INVENTION

It should be noted that technical terms used in the present disclosure are only used to describe specific examples and are not intended to limit the idea of the technology disclosed in the present disclosure. In addition, unless specifically defined otherwise in the present disclosure, the technical terms used in the present disclosure should be interpreted as having a meaning generally understood by a person having ordinary skill in the art to which the technology disclosed in the present disclosure belongs, and should not be interpreted in an excessively broad or excessively narrow sense. In addition, when the technical terms used in the present disclosure are incorrect technical terms that do not accurately express the idea of the technology disclosed in the present disclosure, it should be understood that the technical terms are replaced with the technical terms which can be correctly understood by a person having ordinary skill in the art to which the technology disclosed in the present disclosure belongs. In addition, general terms used in the present disclosure should be interpreted as defined in the dictionary or according to the context, and should not be interpreted in an excessively narrow sense.

Terms including ordinal numbers such as first, second, and the like, which are used in the present disclosure, may be used to describe various components, but the components should not be limited by the terms. The terms are used only to distinguish one component from another component. For example, without exceeding the scope of the present disclosure, a first component may be referred to as a second component, and similarly, the second component may be referred to as the first component.

Hereinafter, the present disclosure will be described in detail with reference to the accompanying drawings. Regardless of reference numerals in the drawings, the same reference numerals will be assigned to identical or similar components, and repeated description thereof will be omitted.

In addition, in describing the technology disclosed in the present disclosure, when it is determined that the detailed description of the related known technology may obscure the concept of the technology disclosed in the present disclosure, the detailed description will be omitted. In addition, it should be noted that the accompanying drawings are only intended to facilitate easy understanding of the idea of the technology disclosed in the present disclosure, and should not be interpreted as limiting the idea of the technology by the accompanying drawings.

Images according to the present disclosure include both still images and moving images unless otherwise specified.

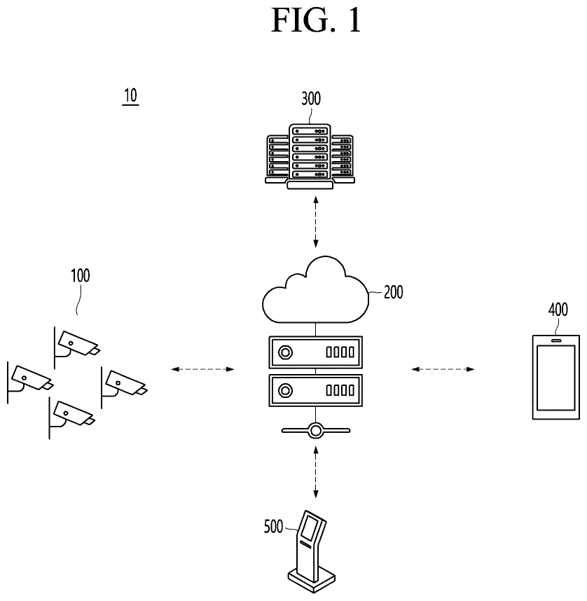

FIG. 1 is a diagram illustrating an example of a conceptual diagram of a guest management system to which a method proposed in the present disclosure is applicable.

The guest management system proposed in the present disclosure may be used in all places where people may stay at guest rooms (for example, hotels, motels, and the like), regions, and the like. Hereinafter, for the convenience of description, a ‘hotel’ will be described as an example, but it should be clarified that the example is not limited thereto.

Referring to FIG. 1, a guest management system (10) may include multiple cameras (100), a cloud server (200), a hotel management system (300), a user terminal (400), a card key issuing device (kiosk, 500), and the like.

The cloud server may be referred to as a first server, and the hotel management system may be referred to as a hotel server, a hotel management server, or a second server.

In addition, the cloud server and the hotel management system may be implemented as one server, and when implemented as one server, the hotel management system may include functions of the cloud server, or the cloud server may include functions of the hotel management system.

The multiple cameras (100) may be classified into four types of cameras (first camera groupcamera group, second camera groupcamera group, third camera groupcamera group, and fourth camera groupcamera group), depending on locations where the cameras are installed inside the hotel. camera groupcamera groupcamera groupcamera groupcamera groupcamera groupNext, the cloud server (200) receives vehicle license plate information of customers scheduled to stay in guest rooms, information of the count of checked-in guests, guest room information, and the like from multiple cameras and the hotel management system, analyzes the received information, and provides types of the guests and information for tracking movement paths of the guests.

Next, the hotel management system (300) stores and manages reservation information for the customers scheduled to stay, guest accommodation information such as the count of the checked-in guests, the types of the guests, and guest history information of the types of the guests and the movement paths.

Next, the user terminal (400) provides a screen for the customer scheduled to stay to connect to the hotel management system, and provides mobile check-in notifications, notifications of restricted areas, and the like to the guests.

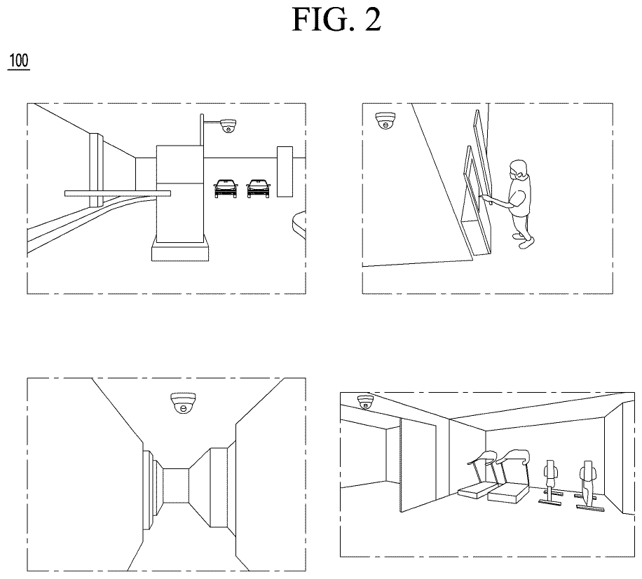

Next, the card key issuing device (500) receives an input of a barcode output to the user terminal, or issues a card key for the reserved guest room when a user (for example, the customer scheduled to stay) inputs information. FIG. 2 is a diagram illustrating an example of the multiple cameras proposed in the present disclosure.

Referring to FIG. 2, the first camera group may include a camera installed in a parking lot of the hotel, the second camera group may include a camera installed in a lobby of the hotel, the third camera group may include a camera installed in a guest room corridor of the hotel, and the fourth camera group may include a camera installed in a communal space of the hotel (for example, a health club, a restaurant, a coffee shop, and the like).

The second camera group may be included in the fourth camera group.

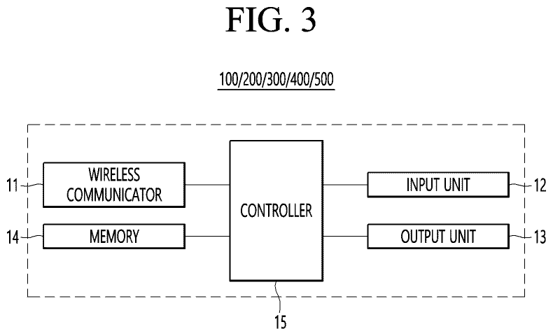

FIG. 3 is an internal block diagram illustrating a device to which the method proposed in the present disclosure is applicable.

FIG. 3 may show a concept of the device including the cameras, the hotel management system, the cloud server, the user terminal, the card key issuing device, and the like.

The devices (100, 200, 300, 400, and 500) may include a wireless communicator (11), an input unit (12), an output unit (13), a memory (14), a controller (15), and the like. The components illustrated in FIG. 3 are not essential for implementing the devices, and thus, the devices described in the present disclosure may have more or fewer components than the components listed above.

More specifically, the wireless communicator of the components may include one or more modules that enable wireless communication between the devices and the wireless communication system, between one device and another device, or between the device and the server. In addition, the wireless communicator may include one or more modules that connect the devices to one or more networks.

The wireless communicator may include at least one of a mobile communication module, a short-range communication module, and a location information module.

The input unit may include a user input unit (for example, a touch key, a mechanical key, and the like) for receiving information from the user. The input unit may additionally include a camera or a video input unit for inputting video signals, a microphone for inputting audio signals, or an audio input unit. Voice data or image data collected from the input unit may be analyzed and processed by a control command of the user.

The output unit generates an output related to visual, auditory or tactile sensations, and may include at least one of a display unit, an acoustic output unit, a haptic module, and an optical output unit. The display unit may be formed as a layer structure with a touch sensor, or may be formed as an integral type to implement a touch screen. This touch screen may function as a user input unit that provides an input interface between the device and the user, and may provide an output interface between the device and the user.

In addition, the memory stores data that supports various functions of the device. The memory may store multiple application programs (or applications) executed by the device, data for an operation of the device, and commands. At least some of these application programs may be downloaded from an external server via wireless communication. In addition, at least some of these application programs may exist on the device from when the application programs are released for basic functions of the device (for example, phone call incoming and outgoing functions or message reception and transmission functions). Meanwhile, the application programs may be stored in the memory, may be installed on the device, and may be executed by the controller to perform the operation (or function) of the device.

In addition to the operation related to the application programs, the controller generally controls an overall operation of the device. The controller may process signals, data, information, and the like which are input or output through the components described above, or may execute the application programs stored in the memory. In this manner, the controller may provide proper information for the user, or may process proper functions for the user.

In addition, the controller may control at least some of the components described in FIG. 13 to execute the application programs stored in the memory. Furthermore, in order to execute the application programs, the controller may operate at least two or more components included in the device in combination with each other.

At least some of the components may cooperate with each other to implement the operation, the control, or the control method of the device according to various examples described below. In addition, the operation, the control, or the control method of the device may be implemented on the device by executing at least one application program stored in the memory.

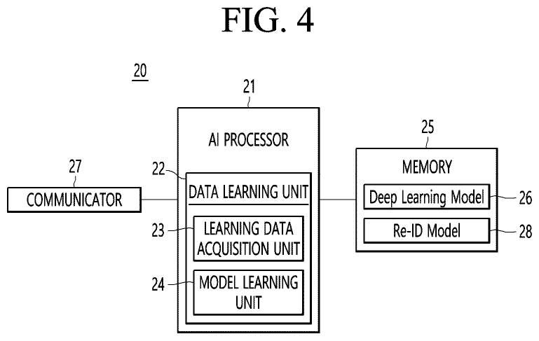

FIG. 4 is a block diagram of an AI device to which the method proposed in the present disclosure is applicable.

The AI device (20) may be included as a portion of the configuration of the camera (100) illustrated in FIG. 1 or FIG. 3, and may be provided to perform at least a portion of AI processing.

The AI device (20) may include an AI processor (21), a memory (25), and/or a communicator (27). When the AI device is included in the camera, the communicator (27) may be omitted.

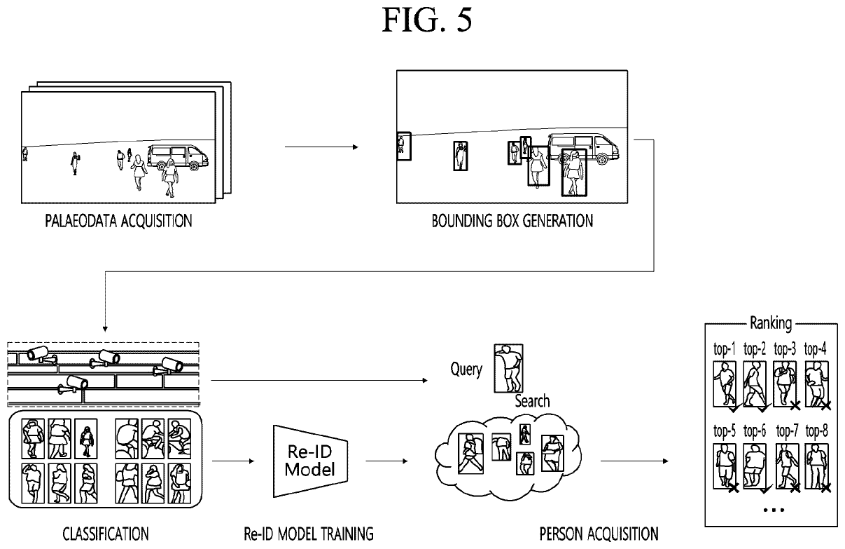

The AI device (20) may be a computing device capable of learning a neural network, may be implemented as various electronic devices such as a server, a desktop PC, a notebook PC, a tablet PC, and the like, and may perform the method proposed in the present disclosure by mounting a Re-ID model which is described in FIG. 5.

The AI processor (21) may learn a neural network by using a program stored in the memory (25). In particular, the AI processor (21) may learn a neural network for recognizing image-related data. Here, the neural network for recognizing the image-related data may be designed to simulate a human brain structure on a computer, and may include a plurality of network nodes having weights, which simulate neurons of a human neural network. Depending on a connection relationship, the plurality of network modes may each transmit and receive data to simulate synaptic activity of neurons in which the neurons transmit and receive signals through synapse. Here, the neural network may include a deep learning model developed from a neural network model. In the deep learning model, the plurality of network nodes may be located in mutually different layers, and transmit and receive data, depending on a convolution connection relationship. Examples of the neural network model include various deep learning techniques such as deep neural networks (DNN), convolutional deep neural networks (CNN), a recurrent Boltzmann machine (RNN), a restricted Boltzmann machine (RBM), deep belief networks (DBN), and deep Q-networks, and are applicable to a field such as computer vision, voice recognition, natural language processing, and voice/signal processing.

Meanwhile, the processor fulfilling the functions as described above may be a general-purpose processor (for example, a CPU), but may be an AI-dedicated processor for artificial intelligence learning (for example, a GPU).

The memory (25) may store various programs and data which are required for the operation of the AI device (20). The memory (25) may be implemented as a non-volatile memory, a volatile memory, a flash memory, a hard disk drive (HDD), or a solid state drive (SDD). The memory (25) is accessed by the AI processor (21), and data reading/recording/modifying/deleting/updating, and the like may be performed by the AI processor (21). In addition, the memory (25) may store a neural network model (for example, a deep learning model (26) or a Re-ID model (28)) generated by using a learning algorithm for data classification/recognition according to the present disclosure.

Meanwhile, the AI processor (21) may include a data learning unit (22) that learns the neural network for data classification/recognition. The data learning unit (22) may learn a reference regarding which learning data to use to determine data classification/recognition and how to classify and recognize data by using the learning data. The data learning unit (22) may acquire learning data to be used for learning, and may learn the deep learning model by applying the acquired learning data to the deep learning model.

The data learning unit (22) may be manufactured in a form of at least one hardware chip to be mounted on the AI device (20). For example, the data learning unit (22) may be manufactured in a form of a dedicated hardware chip for artificial intelligence (AI), or may be manufactured as a portion of a general-purpose processing unit (CPU) or a graphics processing unit (GPU) to be mounted on the AI device (20). In addition, the data learning unit (22) may be implemented as a software module. When implemented as the software module (or a program module including instructions), the software module may be stored in a non-transitory computer readable media that can be read by a computer. In this case, at least one software module may be provided by an OS (Operating System), or may be provided by an application.

The data learning unit (22) may include a learning data acquisition unit (23) and a model learning unit (24).

The learning data acquisition unit (23) may acquire learning data required for the neural network model for classifying and recognizing data. For example, the learning data acquisition unit (23) may acquire image data and/or sample data for being input to a neural network model as learning data.

The model learning unit (24) may train the neural network to have a determination reference on how to classify prescribed data by using the acquired learning data. In this case, the model learning unit (24) may train the neural network model by using supervised learning that uses at least some of the learning data as a determination reference. Alternatively, the model learning unit (24) may train the neural network model by using unsupervised learning that discovers the determination reference by performing self-learning using the learning data without any guidance. In addition, the model learning unit (24) may train the neural network model by using reinforcement learning by using feedback on whether a situation determination result according to the learning is correct. In addition, the model learning unit (24) may train the neural network model by using a learning algorithm including error back-propagation or gradient descent.

When the neural network model is learned, the model learning unit (24) may store the learned neural network model in the memory. The model learning unit (24) may also store the learned neural network model in the memory of the server connected to the AI device (20) via a wired or wireless network.

The data learning unit (22) may further include a learning data preprocessing unit (not illustrated) and a learning data selection unit (not illustrated) to improve analysis results of the recognition model or to save resources or times required for generating the recognition model.

The learning data preprocessing unit may preprocess the acquired data so that the acquired data can be used for situation determination learning. For example, the learning data preprocessing unit may process the acquired data into a preset format so that the model learning unit (24) may use the acquired learning data for image recognition learning.

In addition, the learning data selection unit may select data required for learning from the learning data acquired from the learning data acquisition unit (23) or the learning data preprocessed from the preprocessing unit. The selected learning data may be provided to the model learning unit (24). For example, the learning data selection unit may select only data for objects included in a specific area as the learning data by detecting a specific area from an image acquired by using the camera.

In addition, the data learning unit (22) may further include a model evaluation unit (not illustrated) to improve analysis results of the neural network model.

The model evaluation unit inputs evaluation data to the neural network model, and when the analysis result output from the evaluation data does not satisfy a prescribed criterion, the model evaluation unit may train the model learning unit (22) again. In this case, the evaluation data may be predefined data for evaluating the recognition model. For example, the model evaluation unit may evaluate that the predetermined reference is not satisfied, when the number or a ratio of the evaluation data whose analysis result is inaccurate in the analysis results of the learned recognition model for the evaluation data exceeds a preset threshold value.

The communicator (27) may transmit AI processing results obtained by the AI processor (21) to an external device.

The AI device (20) illustrated in FIG. 4 has been described by being functionally classified into the AI processor (21), the memory (25), and the communicator (27), but it should be noted that the above-described components may be integrated into one module, and may be referred to as an AI module.

FIG. 5 is a diagram illustrating an example of a re-identification method applicable to the method proposed in the present disclosure.

Referring to FIG. 5, a method for performing re-identification (hereinafter, referred to as ‘Re-ID’) will be described.

The Re-identification (Re-ID) refers to a method for detecting the same object by comparing features between a target object in which a specific object is previously found in a different time period, a different space, or a different situation, and a newly detected object.

First, the AI device acquires raw image data from the camera.

Thereafter, the AI device detects a person from the acquired raw image data, and generates a bounding box.

Thereafter, the AI device classifies an image of a person subjected to the bounding box, and trains the Re-ID model which is one of the learning models.

Thereafter, the AI device performs the re-identification to find a person (query person) corresponding to a desired query from person data processed by the bounding box by using the trained model.

### Customer Management Service

In the hotel lobby and the guest room corridors, which are communal spaces, a CCTV is installed for security and safety. However, images of the CCTV cannot be used to provide customer service due to the Personal Information Protection Act. Therefore, the image itself of the CCTV is not utilized for a guest management service proposed in the present disclosure. Data analyzed by the AI and external (PMS) information are combined to perform analysis to fulfill various functions proposed in the present disclosure.

The present disclosure aims to improve customer response in a customer service by visualizing the analyzed information and quickly delivering a situation to hotel operators.

More specifically, in the guest management service proposed in the present disclosure, individual guests are classified by using analysis information (customer gender, age group, shape, and clothing characteristics) not included in the Personal Information Protection Act in the images of the CCTV, and the classified guest is estimated as the same person in the images of multiple cameras by using re-identification (Re-ID).

The guest room number assigned to the guest registered in the guest management system is compared with the count of the guests so that the guests who enter the guest rooms match respective guests (or a group of guests), and the types of the guests are estimated.

In addition, in the guest management service, the movement paths of the guests moving in a group or individually moving in the types of the guests are tracked and analyzed by using image analysis of the cameras installed in communal facilities such as a swimming pool, a store, and a restaurant of the hotel.

In addition, in the guest management service, information of the type of the guest in the corresponding guest room and the movement route during a staying period is transmitted to the management system after the guest completes staying at the guest room and checks out from the guest room, the types of the guest is specified, travel preferences of each guest and each type are analyzed, based on a type and a time of the facility used by the guest, and results of the analysis are used for target marketing.

In addition, the guest management service may be broadly used in a retail sector represented by a small store, a shopping mall, a department store, and the like in a solution for tracking and analyzing the types and the movement paths of the guests inside the hotel.

For example, in a customer management system (system that implements the contents proposed in the present disclosure), each movement path is tracked from a moment that a customer enters a store or a shopping mall. The customer is specified at a moment the customer actually makes a payment and accumulates mileage points. Movement path information, a staying time in each product area, and information on companions are analyzed, and products in which the customer is highly interested are analyzed in detail. In this manner, marketing may be performed, based on preferences of the customer.

As another example, when a VIP customer's vehicle whose information has been provided under prior consent arrives at a department store, the customer management system recognizes a VIP's entry, recognizes special characteristics of the customer in a parking lot, and provides a person in charge with information on the entry and the movement path on a real-time basis. In this manner, a customer response speed may be improved.

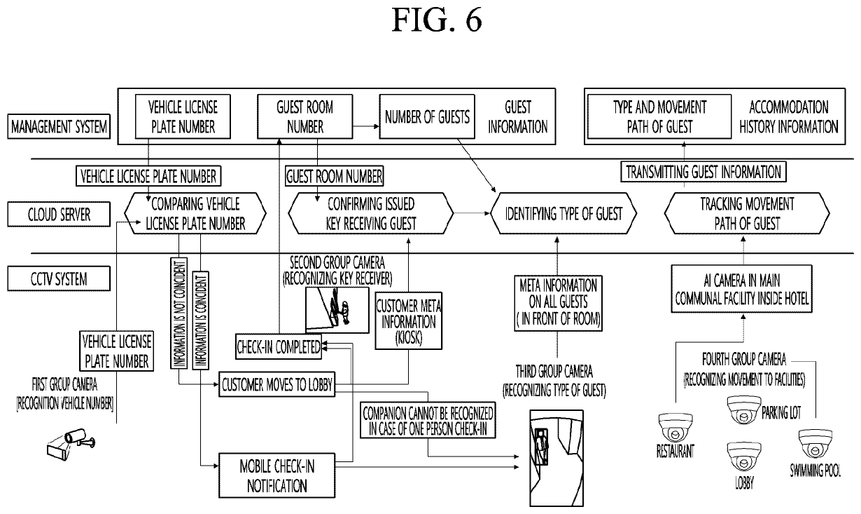

FIG. 6 is a flowchart illustrating an example of a method for analyzing the types of the guests and tracking the movement paths of the guests by using information on the customers scheduled to stay in the guest management system proposed in the present disclosure.

Based on at least four camera groups installed in mutually different locations inside the hotel, the guest management system may include the following processes such as (1) analysis of the vehicle license plate number of the customer scheduled to stay, (2) analysis of the guest to whom a guest room key is issued, (3) analysis of the type of the guest, and (4) tracking analysis of the movement path of the specific guest.

The at least four camera groups may include a first camera group installed in the parking lot of the hotel, a second camera group installed in the hotel lobby, a third camera group installed in the guest room corridor of the hotel, and a fourth camera group installed in the communal space inside the hotel.

Each of the first camera group, the second camera group, the third camera group, and the fourth camera group may include at least one camera, and the at least one camera may be an AI camera including the AI device trained with the above-described Re-ID model.

Referring to FIG. 6, the cloud server acquires the license plate information of the vehicle entering (or entering) the parking lot of the hotel from the first camera group installed in the parking lot of the hotel.

In addition, the cloud server receives information on the customer scheduled to stay who makes a reservation at the hotel from the hotel management system.

The hotel management system is a device in which a program for managing the hotel such as guest management is implemented as a web or an application, may provide a hotel management program to a user terminal, and may be referred to as a hotel management server, a hotel server, a second server, and the like.

The information on the customer scheduled to stay includes the vehicle license plate information, the count of guests, and the date of staying which are input when the customer scheduled to stay in the hotel makes a reservation by using the user terminal.

Thereafter, the cloud server compares the vehicle license plate information (first vehicle license plate information) received from the first camera group with the vehicle license plate information (second vehicle license plate information) received from the hotel management system.

As a result of the comparison, when the first vehicle license plate information and the second vehicle license plate information are identical to or coincident with each other, the cloud server transmits mobile check-in notification information so that the customer scheduled to stay can perform mobile check-in.

The mobile check-in notification information may be transmitted to the hotel management system and/or may be transmitted to the user terminal of the customer scheduled to stay.

The customer scheduled to stay may perform the mobile check-in for his or her stay in such a manner that a barcode result output to a screen of the user terminal is recognized by a barcode reader of the card key issuing device installed near an elevator (for example, next to the elevator).

As a result of performing the mobile check-in, the customer scheduled to stay may receive a card key for the guest room at which he or she stays from the card key issuing device, and the hotel management system manages the customer scheduled to stay as the guest when the mobile check-in of the customer scheduled to stay is completed.

When the comparison results show that the first vehicle license plate information and the second vehicle license plate information are not identical to or not coincident with each other, the customer scheduled to stay is required to go to the hotel lobby to perform a check-in procedure.

When the customer scheduled to stay performs the check-in procedure for his or her stay directly in the lobby, the customer scheduled to stay inputs accommodation information confirmed or received in the lobby to the card key issuing device (for example, check-in kiosk), and receives the card key for the guest room at which he or she stays.

Here, the accommodation information confirmed or received in the lobby may be transmitted to the user terminal of the customer scheduled to stay, and may be transmitted to the card key issuing device through communication such as NFC and Bluetooth between the user terminal and the card key issuing device.

The card key issuing device may transmit the accommodation information of the guest who completes the check-in after the card key is issued to the hotel management system.

The accommodation information of the guest is input to the card key issuing device, and may include information on the guest room number of the guest, the check-in time, the count of guests, the staying period, and the like.

In addition, the hotel management system may transmit the accommodation information of the guest to the cloud server.

Here, the second camera group installed in the lobby of the hotel may recognize a person who receives the card key from the card key issuing device during check-in, and may transmit image capturing information related to the recognition and the accommodation information related to the guest to the hotel management system.

The image capturing information may include information of a card key recipient, the companions of the guest, and the like.

By using this information, the hotel management system and/or the cloud server may acquire the accommodation information related to the guest who receives the issued card key.

Next, the third camera group installed in the guest room corridor of the hotel detects the type of the guest entering the guest room or exiting from the guest room, and transmits information of the detected type of the guest to the cloud server.

The information of the type of the guest may include meta information of all of the checked-in guests.

The cloud server analyzes the type of the guest by using information acquired by the second camera group, information acquired by the third camera group, and the accommodation information of the guest which is provided by the hotel management system.

Here, the type of the guest may be classified into family members, couples, friends, and the like.

Next, the fourth camera group installed in the communal spaces of the hotel capture images of a specific guest in the communal facilities of the hotel, and transmits information related to the movement path, such as a movement path, a location, and a movement time of the specific guest whose image is captured, to the cloud server.

The cloud server may analyze the movement path of the specific guest by using the information related to the movement path of the specific guest, and may provide a result of the analysis to the hotel management system.

The specific guest may include VIP customers of the hotel, infants, disabled customers, and the like.

The fourth camera group may include multiple cameras, and at least one camera may be installed in each of the communal spaces of the hotel.

As described above, the information of the type of the guest and information related to the movement path of the guest may be expressed as accommodation history information of the guest.

As another example, a method for directly specifying the customer without any customer identification process by using a vehicle model of a vehicle and specific information of the same vehicle.

The first camera group installed in the parking lot of the hotel or around an entrance of the hotel captures images of the surrounding area.

When a preset vehicle model is detected in the captured image, the first camera group tracks the vehicle. When a person (or a customer) gets out of the vehicle, the first camera group determines or specifies the person as the specific customer without any process of identifying the person.

Here, the first camera group tracks the vehicle from a time at which the vehicle is detected until the person gets out of the vehicle.

The first camera group transmits information related to the specified or determined specific customer to the cloud server.

Thereafter, the cloud server confirms the information on the specific customer which is received from the first camera group. When it is determined that the specific customer corresponds to the customer managed by the hotel, the cloud server transmits mobile check-in notification information that allows the specific customer to stay at any one room of the guest rooms reserved in advance or assigned in advance for the specific customer.

The mobile check-in notification information may be transmitted to the hotel management system and/or may be transmitted to the user terminal of the specific customer.

The specific customer may perform the mobile check-in for his or her stay in such a manner that the barcode result output to the screen of the user terminal is recognized by the barcode reader of the card key issuing device installed near the elevator (for example, next to the elevator).

As a result of performing the mobile check-in, the specific customer may receive the card key for the guest room at which he or she stays, from the card key issuing device, and the hotel management system manages the specific customer as the guest, when the mobile check-in of the specific customer is completed.

In addition, the card key issuing device may transmit the accommodation information of the specific customer who completes the check-in by issuing the card key, to the hotel management system.

The accommodation information of the specific customer is input to the card key issuing device, and may include information of the guest room number, the check-in time, the count of the guests, the staying period, and the like.

In addition, the hotel management system may transmit the accommodation information of the specific customer to the cloud server.

Here, the second camera group installed in the lobby of the hotel may recognize a person who receives the card key from the card key issuing device during check-in, and may transmit the image capturing information related to the recognition and the accommodation information related to the specific customer, to the hotel management system.

The image capturing information may include information of the card key recipient, the companions of the specific customer, and the like.

By using this information, the hotel management system and/or the cloud server may acquire the accommodation information related to the specific customer who receives the issued card key.

Next, the third camera group installed in the guest room corridor of the hotel detects the type of the specific customer entering the guest room or exiting from the guest room, and transmits the information of the detected type of the specific customer, to the cloud server.

The information of the type of the specific customer may include meta information of all of the checked-in guests.

The cloud server analyzes the type of the specific customer by using information acquired by the second camera group, information acquired by the third camera group, and accommodation information on the specific customer which is provided by the hotel management system.

Here, the type of the specific customer may be classified into family members, lovers, friends, and the like.

Next, the fourth camera group installed in the communal space of the hotel capture images of the specific customer in the communal facilities inside the hotel, and transmits information related to the movement path, such as the movement path, the location, and the movement time of the specific guest whose image is captured, to the cloud server.

The cloud server may analyze the movement path of the specific customer by using the information related to the movement path of the specific customer, and may provide a result of the analysis to the hotel management system.

The fourth camera group may include multiple cameras, and at least one camera may be installed in each of the communal spaces of the hotel.

As described above, the information of the type of the specific customer and the information related to the movement path of the guest may be expressed as the accommodation history information of the guest.

Next, operation modes of the first to fourth camera groups for each step performed by the above-described guest system proposed in the present disclosure will be described in more detail for the following processes of (1) analyzing the vehicle license plate number of the customer scheduled to stay, (2) analyzing the customer who receives the issued guest room key, (3) analyzing the type of the guest, and (4) tracking and analyzing the movement path of the specific guest.

The guest system performs functions such as check-in assistance for the guests, analyzing the types of the guests, analyzing the movement paths of the guests, and tracking the specific guest by using the multiple camera groups, the cloud server, the user terminals, the hotel management system, the card key issuing device, and the like.

That is, the guest system receives and analyzes the vehicle license plate number, the count of the checked-in guests, and the guest room information of the customer scheduled to stay, from the cloud server, and transmits hotel usage information such as the accommodation information and the accommodation history information of the guests, to the hotel management system.

### Guest Check-In Assistance Method

A method for assisting the check-in of the guest will be described.

The first camera group is installed in the parking lot of the hotel, the second camera group is installed in the hotel lobby, the third camera group is installed in the guest room corridor of the hotel, and the fourth camera group is installed in the communal space of the hotel. In order to assist the check-in of the guest, the first to third camera group are operated in an active mode, and the fourth camera group is operated in an inactive mode.

The first camera groups to the fourth camera groups may be operated in the active mode or the inactive mode, and the active mode or the inactive mode may be set to a specific mode in such a manner that the specific mode is instructed by using the hotel management system or the cloud server or in accordance with a user's input.

Here, the specific mode represents the active mode or the inactive mode.

First, the cloud server receives information of the customer scheduled to stay, who makes a reservation at the hotel by using the hotel management system.

The information of the customer scheduled to stay may be input through the user terminal of the corresponding guest, and may be transmitted to the hotel management system. The information of the customer scheduled to stay may include a name, a gender, a phone number, an address, a staying period, the count of checked-in guests, guest room information, whether meals are included, payment information, whether the vehicle is parked, vehicle license plate information, and the like of the customer scheduled to stay.

In addition, the first camera group captures images of the vehicle entering the parking lot of the hotel, and transmits the license plate information of the image-captured vehicle, to the cloud server.

The cloud server compares the vehicle license plate information with the vehicle license plate information received from the first camera group in the information of the customer scheduled to stay.

As a result of the comparison, when the license plate information of the vehicles is identical to or coincident with each other, the cloud server transmits a notification to the hotel management system for the customer scheduled to stay who corresponds to the license plate information of the vehicle as a reservation holder, and the hotel management system transmits a mobile check-in notification to the user terminal of the customer scheduled to stay. In this case, the customer scheduled to stay performs the mobile check-in by using the user terminal. When the mobile check-in is completed, the hotel management system changes the reservation holder to the guest, and transmits the changed information to the cloud server.

As a result of the comparison, when the license plate information of the vehicles is not identical to or is not coincident with each other, the cloud server classifies the customer scheduled to stay as an unregistered person, and transmits a notification to the hotel management system so that the unregistered person directly check in at the hotel lobby instead of the mobile check-in.

When the customer scheduled to stay, who is classified as the unregistered person, directly check in at the hotel lobby, the hotel management system changes the customer scheduled to stay from the unregistered person to the guest.

In addition, when the customer scheduled to stay, who receives the notification for the mobile check-in does not perform the mobile check-in by using the user terminal for a certain period of time, the hotel management system transmits the notification for the mobile check-in again to the user terminal.

Here, when the customer scheduled to stay, who is classified as the unregistered person, checks in at the hotel lobby, and becomes the guest, the second camera group installed in the hotel lobby collects Re-ID information of the guest.

The Re-ID information of the guest includes information of an image of the guest that matches the above-described guest in the images collected by using the second camera group.

In addition, the cloud server receives information on the guests who check-in at the hotel lobby after being classified as the unregistered persons (count of the guests, guest room information of the guests, and the like.) from the hotel management system.

In addition, the third camera group installed in the guest room corridor of the hotel collects the Re-ID information of the guests who enter the guest rooms after being classified as the reservation holders and performing the mobile check-in.

Whether the guest who checks in by using the mobile phone enters the guest room directly without passing through other places may be determined by whether the images of the guest are captured by the second camera group and the third camera group within a predetermined time.

In addition, the third camera group confirms the Re-ID information of the guest and the count of the checked-in guests, and transmits a result of the confirmation to the cloud server.

The third camera group collects the Re-ID information of all persons entering the guest rooms, and transmits the Re-ID information to the cloud server.

Here, when the registered count information of the checked-in guests in the hotel management system and the count information of the checked-in guests received by the third camera group are identical to each other, the cloud server determines that all of the checked-in guests have completed entering the guest rooms of the hotel, and the hotel management system processes the counted guests as guests who have entered the guest rooms of the hotel.

### Method for Analyzing Types of Guests

Next, a method for analyzing types of guests will be described.

Similarly, the first camera group is installed in the parking lot of the hotel, the second camera group is installed in the hotel lobby, the third camera group is installed in the guest room corridor of the hotel, and the fourth camera group is installed in the communal space inside the hotel. In order to analyze the types of the guests, the first camera group, the second camera group, and the fourth camera group are operated in the inactive mode, and the third camera group is operated in the active mode.

First, the cloud server receives information on the count of the checked-in guests and the guest room information (room number, and the like.) for each of the guest rooms on each guest room floor where the third camera group is installed, from the hotel management system.

In addition, the cloud server receives gender information and age information which are related to the count of the checked-in guests entering each of the guest rooms, from the third camera group, and analyzes the information.

In addition, the cloud server performs filtering of a double-confirmed person by using the Re-ID information on the count of the guests staying in the guest room.

The cloud server compares the count of the guests in the guest rooms registered in the hotel management system with the count of the guests having the same gender and the same age.

When results of the comparison are coincident with or identical to each other, the cloud server analyzes the types of the guests, based on the count of the guests in the guest room.

Here, the third camera group classifies all persons entering the guest rooms by using the Re-ID information, and analyzes the gender and the age group of the checked-in guests.

Here, the cloud server waits until the compared count of the guests become identical to each other, and thereafter, analyzes the types of the guests, based on the acquired information.

The types of the guests may be classified into family members, couples, friends, and the like.

### Method for Analyzing Movement Paths of Guests

Next, a method for analyzing the movement paths of the guests will be described.

Similarly, the first camera group is installed in the parking lot of the hotel, the second camera group is installed in the hotel lobby, the third camera group is installed in the guest room corridor of the hotel, and the fourth camera group is installed in the communal space inside the hotel. In order to analyze the movement paths of the guests, the first camera group and the second camera group are operated in the inactive mode, and the third camera group and the fourth camera group are operated in the active mode. When the communal space includes the lobby, the second camera group may be included in the fourth camera group, and may be operated in the active mode.

First, the third camera group collects the Re-ID information of the persons exiting from the guest rooms, and transmits the information to the cloud server.

The cloud server selects the guests exiting from the guest rooms, and analyzes the movement paths of the selected guests by using images acquired by the third camera group and the fourth camera group.

When the movement paths of the guests are analyzed, the cloud server excludes the guests staying in the guest rooms from an analysis comparison target group, and confirms the entry and the exit of the guests in the guest rooms where multiple guests stay.

The cloud server estimates the most similar person in all of the checked-in guests staying in the guest rooms by using the Re-ID information on the person, and includes the estimated person in the comparison target group.

The cloud server maintains the other person remaining in the guest room as the comparison target group.

In addition, in order to analyze the movement paths of the guests, the cloud server compares the guests recognized in the communal spaces of the hotel, such as a restaurant, a coffee shop, and a conference room, with the comparison target group, and estimates the recognized guests as the previously selected guests.

Here, when the guest is detected or discovered in a space where no person is allowed to enter other than the communal space, the cloud server transmits a notification to the hotel management system and/or the user terminal to notify that a certain person enters the space where no person is allowed to enter.

In addition, the cloud server records and stores a movement location, a movement time, a staying location, a staying time, and the like of the guest inside the communal space in order to track the movement path by using image information acquired by the fourth camera group.

The cloud server excludes the guest from the comparison target group when the guest uses a facility in the communal space, and includes the guest again in the comparison target group when the camera discovers or detects that the guest uses the facility in the communal space and comes out to the corridor or the like.

Here, the fourth camera group collects the Re-ID information on the person in the communal space inside the hotel.

Here, the second camera group may be included in the fourth camera group.

### Method for Tracking Specific Customer

Next, a method for tracking a specific customer (or a specific guest) will be described.

Similarly, the first camera group is installed in the parking lot of the hotel, the second camera group is installed in the hotel lobby, the third camera group is installed in the guest room corridor of the hotel, and the fourth camera group is installed in the communal space inside the hotel. In order to track the specific customer, the first camera group and the second camera group are operated in the inactive mode, and the third camera group and the fourth camera group are operated in the active mode. When the communal space includes the lobby, the second camera group may be included in the fourth camera group, and may be operated in the active mode.

The cloud server separately stores and manages intensive care customers (for example, VIP customers, disabled customers, infants, and the like.).

Here, information on the intensive care customers may be received from the hotel management system, and may be set in the cloud server at a specific time period (for example, at night).

In order to track the specific customer, such as the intensive care customers, the cloud server excludes the customer who stays in the guest room from the comparison target group, and confirms the entry and the exit of the guests in the guest room where multiple persons stay.

The cloud server estimates the most similar person in all of the checked-in guests in the guest room by using the Re-ID information on the person, and includes the estimated person in the comparison target group.

The cloud server determines whether the estimated person is identical to the intensive care customer, that is, the specific customer, and when it is determined that both are identical, the cloud server notifies the hotel management system that the specific customer is detected.

The cloud server maintains the other person remaining in the guest room as the comparison target group.

In addition, in order to track the specific customer, the cloud server compares the guest recognized in the communal space such as the restaurant, the coffee shop, and the conference room with the comparison target group, and estimates the recognized person as the specific customer.

Here, when the specific customer is detected in a space where no person is allowed to enter, other than the communal space, the cloud server transmits a notification to the hotel management system and/or the user terminal to notify that the specific customer enters the space where no person is allowed to enter.

In addition, the cloud server records and stores the movement location, the movement time, the staying location, the staying time, and the like of the specific customer inside the communal space by using information acquired by the fourth camera group.

The cloud server excludes the specific customer from the comparison target group, when the specific customer uses the facility in the communal space, and includes the customer in the comparison target group again, when the camera discovers or detects that the specific customer uses the facility in the communal space and comes out to the corridor or the like.

In addition, the hotel management system may transmit a dedicated page which can confirm the location of the specific customer corresponding to the intensive care customer on a real-time basis, and a notification which can notify the information on a real-time basis.

The fourth camera group collects the Re-ID information on the person in the communal space inside the hotel.

Here, the second camera group may be included in the fourth camera group.

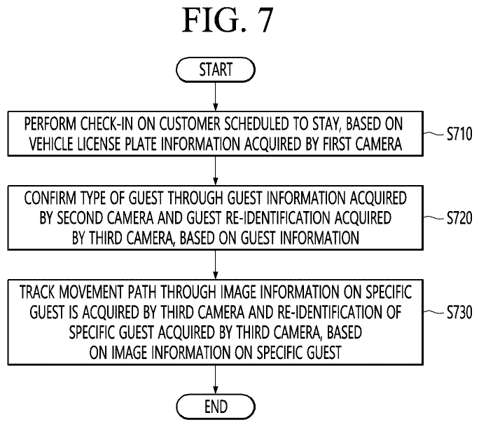

FIG. 7 is a flowchart illustrating an example of a method for managing the guests which is proposed in the present disclosure.

That is, FIG. 7 illustrates an example of a method for operating the server to monitor a guest usage status by using at least one camera.

First, the server performs the check-in for the customer scheduled to stay, based on the vehicle license plate information acquired by the first camera (S710).

A step of performing the check-in may include a step of comparing the vehicle license plate information acquired by the first camera with the vehicle license plate information registered in advance in the management system, and a step of providing the mobile check-in for the customer scheduled to stay or providing the direct check-in in the lobby, based on a result of the comparison.

The server confirms the type of the guest entering the guest room by using the guest information acquired by the second camera and the re-identification (Re-ID) information on the guest which is acquired by the third camera, based on the guest information (S720).

The server tracks the movement path of the specific guest by using the image information of the specific guest exiting from the guest room, which is acquired by the third camera, and the re-identification (Re-ID) information on the specific guest, which is acquired by the fourth camera, based on the image information on the specific guest (S730).

The first camera may be installed in the parking lot of the hotel, the second camera may be installed in the lobby of the hotel, the third camera may be installed in the guest room corridor of the hotel, and the fourth camera may be installed in the communal space of the hotel.

In addition, the server may analyze the confirmed type of the guest and the tracked movement path of the specific guest, and may generate the accommodation history information of the guest, based on a result of the analysis.

Here, the customer scheduled to stay is a customer who makes a reservation in advance by using the management system that manages the guests, and the guest may be a customer who completes the check-in for the guest room.

The guest information includes information on the count of the checked-in guests staying at the guest room and the guest room number, and the information on the checked-in guests may include the count of the checked-in guests staying at the guest room and image information on the checked-in guests staying at the guest room.

The types of the guests may include at least one of a relationship between the checked-in guests staying at the guest room, the gender of the checked-in guests, and the age group of the checked-in guests.

The relationship between the checked-in guests may be one of the friends, the family members, and the lovers.

The types of the guests may be confirmed when the count of the checked-in guests staying at the guest room, which is included in the guest information, and the count of the checked-in guests staying at the guest room, which is acquired by the third camera, are identical to each other.

Hereinafter, a method for tracking the movement path of the specific guest in Step S730 will be described in more detail.

The server confirms whether the specific guest is present in the first image acquired by the third camera.

The server confirms whether the specific guest is present in the second image acquired by the fourth camera.

The server determines the location of the specific guest, based on whether the specific guest is present in the second image.

The location may be a handover zone area indicating an area connected to the doorway of the guest room or another space.

The server updates location information of the specific guest, based on the determined location, and tracks the specific guest.

When the specific guest is present in the first image and the specific guest is not present in the second image, the server confirms whether the specific guest is located at the doorway of the guest room by using the first image.

When the specific guest is located at the doorway of the guest room, the server determines that the specific guest enters the guest room.

When the specific guest is not located at the doorway of the guest room, the server confirms whether the specific guest is located in the handover zone area.

The server searches for a person related to the specific guest in a space connected to the handover zone area, and compares the specific guest with the searched person by using a re-identification (Re-ID) algorithm.

As a result of the comparison, when the specific guest and the searched person are identical or similar to each other, the server maps the searched person to the specific guest.

Alternatively, as a result of the comparison, when the specific guest and the searched person are not identical or not similar to each other, the server determines that tracking of the specific guest fails.

When the specific guest is not present in the first image and the specific guest is present in the second image, the server confirms whether the specific guest is located at the doorway of the guest room by using the second image.

When the specific guest is located at the doorway of the guest room, the server determines that the specific guest exits from the guest room.

When the specific guest is not located at the doorway of the guest room, the server confirms whether the guest is located in the handover zone area.

When the specific guest is located in the handover zone area, the server determines that the specific guest moves to a space connected to the handover zone area.

Next, a method for tracking a person in a specific place by using the camera will be described from a viewpoint of an operation of the camera.

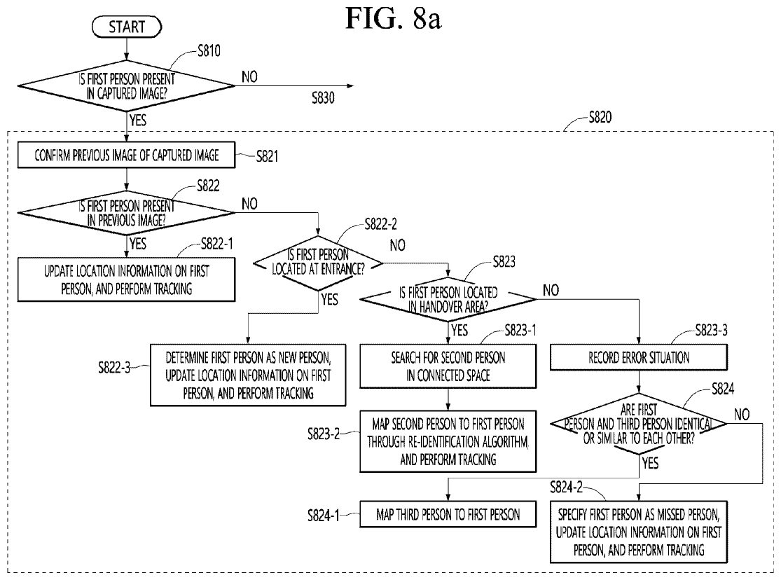

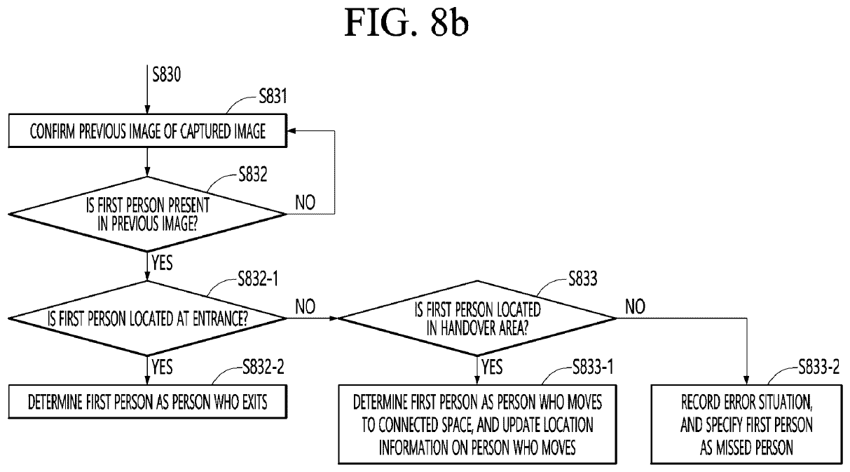

FIG. 8 is a flowchart illustrating an example of a tracking method applicable to the method proposed in the present disclosure.

First, the camera (or a camera group) installed at a specific location captures video (or an image).

The camera or a detector of the camera confirms the captured image, and determines whether a person is present within a field of view of the camera (S810).

As a result of the determination (1), when the person is present, Step S820 below is performed, and (2) when the person is not present, Step S830 below is performed.

A specific step in S820 will be described with reference to FIG. 8a, and a specific step in S830 will be described with reference to FIG. 8b. That is, FIG. 8a illustrates a procedure when the person is present in the captured image, and FIG. 8b illustrates a procedure when the person is not present in the captured image.

Hereinafter, in order to avoid ambiguity caused by the use of the same term, the person in Step S810 will be referred to as a first person. In addition, a procedure performed when the person is present in Step S810 will be described with reference to FIG. 8a, and a procedure performed when the person is not present in Step S810 will be described with reference to FIG. 8b.

First, Step S820 performed when the person is present in Step S810 will be described.

When it is determined that the first person is present in Step S810, the camera confirms the previously captured image (or the previously captured image or a status of the previous screen) (S821).

The camera confirms whether the first person is present within a field of view of the camera in Step S821 (S822).

When the first person is present in Step S822, the camera or a tracker of the camera tracks the first person, and updates information related to the location of the first person (S822-1).

When the first person is not present in Step S822, the camera confirms whether the first person is located at the doorway (S822-2).

In Step S822-2, when the first person is located at the doorway, the camera determines the first person as a new person, updates information related to the location of the first person, and tracks the first person (S822-3).

In Step S822-2, when the first person is not located at the doorway, the camera confirms whether the first person is located in the handover zone area (S823).

The handover zone area (or space) represents an area where one space is connected to another space, is included in the space, and a handover zone connects two spaces.

In Step S823, when the first person is located in the handover zone area, the camera finds (or searches for) a second person from the connected area (S823-1).

In this case, the camera evaluates the second person by using the re-identification (Re-id) algorithm. When a result of the evaluation is satisfactory, the second person is mapped to the first person, and the tracker is operated to track the second person (S823-2).

When the first person is not located in the handover zone area in Step S823, the camera records and stores an error situation (S823-3).

The camera compares a recently missed person (third person) in the connected space with the first person by using the re-identification algorithm.

In Step S824, it is confirmed whether the first person and the missed person (third person) are similar to each other (S824).

In Step S824, when the first person and the third person are similar to each other, the camera maps the third person to the first person with low accuracy (S824-1).

In Step S824, when the first person and the third person are not similar to each other, the camera determines (or specifies) the first person as the missed person, updates information related to the location of the first person, and performs tracking (S824-2).

Next, a case where the first person is not present in Step S810 will be described.

In Step S810, when the first person is not present, the camera confirms the previously captured image (or a status of the previous screen) (S831).

The camera confirms whether the first person is present within the field of view of the camera in Step S831 (S832).

When the first person is present in Step S832, the camera confirms whether the first person is located in an area of the doorway (S832-1).

In Step S832-1, when the first person is located in the area of the doorway, the camera determines that the first person exits from the place (S832-2).

In Step S832-1, when the first person is not located in the area of the doorway, the camera confirms whether the first person is located in the handover zone area (S833).

In Step S833, when the first person is located in the handover zone area, the camera determines that the first person moves to the connected space, and updates information related to the location of the moved person (S833-1).

In Step S833-1, when the first person is not located in the handover zone area, the camera records and stores the error situation, tags the first person as the missed person, and determines the first person as the person who exits from the place (S833-2).

Hereinafter, the terms used in the present disclosure will be briefly defined and clarified as follows.

First, the location represents the location of the person, and serves as a reference role for dividing the DB.

A gate represents a terminal of a closed system.

The space generally classifies an area visible to the camera as the space, and allocates an area not visible to the camera as a shaded space. When the shaded space is not allocated, camera tracking cannot be assisted.

The handover zone is an area where a space is connected to another space, is included in the space, and the handover zone connects two spaces.

The invisible space is connected to space, but is an invisible place since there is no camera.

A stair is a connection space connected to stairs, an elevator, and the like, may connect mutually different floors, and is a place where people can stay for a longer period of time than a general invisible space.

The camera is a video sensor, and simple information (Mac, IP address, and the like) on where the camera is installed in any location is set.

The area is a closed system, and is an independent space in which the handover is not performed in mutually different areas and the tracking cannot be assisted. Occupancy may be obtained and the tracking may be performed inside the area.

The entrance is limited to a case where a person is newly created in a space where the person enters, and the newly created person leaves the space where the person enters, moves to a general area, and moves to a critical area. In this case, a new person is created.

The exit represents a case where a person moves to a space where the person exits from the critical area and thereafter, disappears from the space. In this case, the existing person is considered as the person who exits from the space.

The handover zone may be set as an entrance space or an exit space.

The handover zone space includes four points, and needs to be wide enough to be captured by the camera at least once even when a person moves quickly.

In the same scenario as the entry/exit space, a person who newly enters through the handover zone is searched by being limited to a collided person in persons who exit to the connected handover zone.

A non-connected handover zone can also be set. In the space, a person may move to the invisible area through the invisible handover zone, or may enter the space through the handover zone from the invisible area.

The space where the person is movable through the invisible handover zone has a separate space ID, and all persons who enter this space may be candidates.

Alternatively, the camera may set a time-dependent priority to find the person in another handover zone or in a previously missed handover zone.

The missed person is a person who disappears from the general space while being tracked by the camera, or represents a case where a person who is not tracked suddenly appears in the general space.

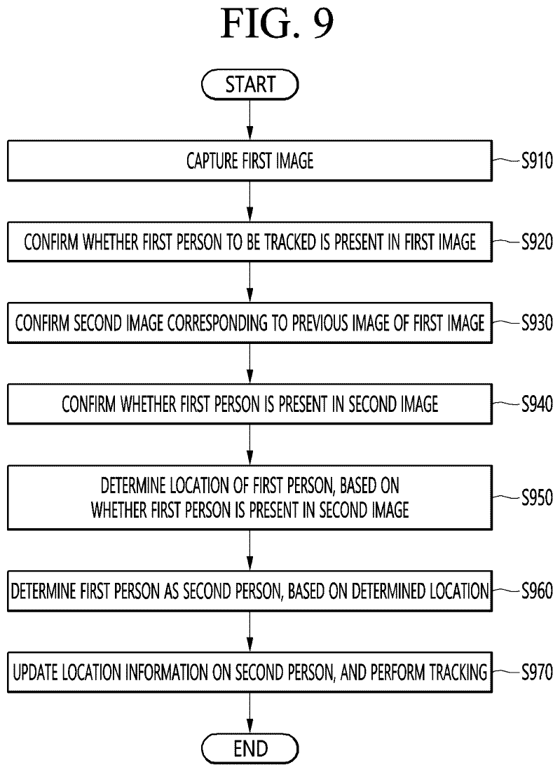

FIG. 9 is a flowchart illustrating an example of a method for tracking a person by using the camera proposed in the present disclosure.

Here, the camera may be installed in at least one of the parking lot of the hotel, the hotel entrance, the hotel lobby, or the corridor of each floor of the hotel, and the person may be the guest of the hotel. Without being limited thereto, the tracking method in FIG. 9 may be performed in other places in the same manner.

First, the camera captures a first image (S910).

The camera confirms whether a first person to be tracked in the first image is present (S920).

The camera confirms a second image corresponding to a previous image of the first image (S930).

The camera confirms whether the first person is present in the second image (S940).

The camera determines the location of the first person, based on whether the first person is present in the second image (S950).

The location may be a handover zone area indicating the doorway of the specific place or the area connected to another space.

The camera determines the first person as the second person, based on the determined location (S960).

The second person may be a new person who enters the specific place, a person who exits from the specific place, a person who moves to another space, or a missed person during the tracking.

The camera updates location information of the determined second person, and tracks the second person (S970).

The camera determines whether the first person is located at the doorway by using the first image, when the first person is present in the first image and the first person is not present in the second image.

When the first person is located at the doorway, the camera may determine the first person as the new person.

When the first person is not located at the doorway, the camera determines whether the person is located in the handover zone area.

When the first person is located in the handover zone area, the camera searches for the second person in a space connected to the handover zone area, maps the first person and the second person by using the re-identification (Re-ID) algorithm, and tracks the first person.

When the first person is not located in the handover zone area, the camera searches for a third person related to the first person in a space connected to the handover zone area.

When the first person and the third person are identical or similar to each other, the camera maps the third person to the first person.

Alternatively, when the first person and the third person are not identical or similar to each other, the camera determines the first person as the missed person.

When the first person is not present in the first image and the first person is present in the second image, the camera determines whether the first person is located at the doorway by using the second image.

When the first person is located at the doorway, the camera may determine the first person as the person who exits.

When the first person is not located at the doorway, the camera determines whether the person is located in the handover zone area.

When the first person is located in the handover zone area, the camera may determine the first person as a person who moves to the space connected to the handover zone area.

In addition, the camera may transmit information related to the tracking of the second person to the server.

The examples described above are combinations of the components and the features of the present disclosure in a prescribed form. Each of the components or the features should be considered as an optional element unless otherwise explicitly stated. Each of the components or the features may be implemented in a form which is not combined with other components or features. In addition, the present disclosure may be adopted by combining some of the components and/or the features. The order of the operations described in the present disclosure may be changed. Some components or features in a certain example may be included in another example, or may be replaced with corresponding components or features of another example. It is obvious that claims which do not have an explicit citation relationship in the appended claims may be combined, or may be included as a new claim by amending the claims after the application of the present disclosure.

The present disclosure may be implemented by various means, for example, hardware, firmware, software, or a combination thereof. In a case of hardware implementation, the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In a case of firmware or software implementation, the present disclosure may be implemented in a form of a module, a procedure, a function, and the like which performs functions or operations described above. A software code may be stored in a memory, and may be driven by a processor. The memory may be located inside or outside the processor, and may exchange data with the processor by various means which are already known.

It will be apparent to those skilled in the art that the present disclosure can be embodied in other specific forms within the scope not departing from the essential characteristics of the present disclosure. Accordingly, the detailed description should not be interpreted in all respects as restrictive but as illustrative. The scope of the present disclosure should be determined by reasonable interpretation of the appended claims, and all changes within the equivalent scope of the present disclosure are included in the scope of the present disclosure.

### INDUSTRIAL APPLICABILITY

A method for monitoring guest usage status by using at least one camera in the present disclosure has been described with a focus on an example applied to a CCTV. Meanwhile, the method is applicable to various other imaging systems.

What is claimed is:

1. A method for monitoring a guest usage status through at least one camera, the method comprising:
performing check-in for a customer scheduled to stay, based on vehicle license plate information acquired by a first camera;
confirming types of guests entering a guest room by using guest information of the guest which is acquired by a second camera and re-identification (Re-ID) of the guest which is acquired by a third camera, based on the guest information; and
tracking a movement path of a specific guest by using image information of the specific guest coming out of the guest room which is acquired by the third camera and the re-identification of the specific guest which is acquired by a fourth camera, based on the image information of the specific guest.

2. The method of claim 1, further comprising:
analyzing the confirmed type of the guest and the tracked movement path of the specific guest; and
generating accommodation history information of the guest, based on a result of the analysis.

3. The method of claim 1, wherein the customer scheduled to stay includes the guest who has made a reservation through a management system for managing guests in advance, and the checked-in guest includes the guest who has completed check-in for the guest room.

4. The method of claim 1, wherein the guest information includes information of t checked-in guests staying in the guest room and the guest room's number, and the information of the checked-in guests staying in the guest room includes a count of the checked-in guests staying in the guest room and image information of the checked-in guests staying in the guest room.

5. The method of claim 1, wherein the types of the guests include at least one of a relationship between the checked-in guests staying in the guest room, a gender of the checked-in guests, and an age group of the checked-in guests.

6. The method of claim 5, wherein the relationship between the checked-in guests is one of friends, family members, and lovers.

7. The method of claim 6, wherein the types of the guests is confirmed upon determination that count of the checked-in guests of the guest room which is included in the guest information and the count of the checked-in guests in the guest room which is acquired by the third camera are identical to each other.

8. The method of claim 3, wherein the performing the check-in includes comparing the vehicle license plate information acquired by the first camera with the vehicle license plate information registered in advance in the management system, and in accordance with a result of the comparison, providing the customer scheduled to stay with mobile check-in or direct check-in in a lobby.

9. The method of claim 1, wherein the first camera is installed in a parking lot of a hotel, the second camera is installed in a lobby of the hotel, the third camera is installed in a guest room corridor of the hotel, and the fourth camera is installed in a communal space of the hotel.

10. The method of claim 1, wherein the tracking the movement path of the specific guest includes confirming whether the specific guest is present in a first image acquired by the third camera, confirming whether the specific guest is present in a second image acquired by the fourth camera, determining a location of the specific guest, based on whether the specific guest is present in the second image, and updating location information of the specific guest, based on the determined location.

11. The method of claim 10, wherein the location is a guest room doorway or a handover zone which represents an area connected to another space.

12. The method of claim 11, further comprising:
confirming whether the specific guest is located at the doorway of the guest room by using the first image, upon determination that the specific guest is present in the first image and the specific guest is not present in the second image.

13. The method of claim 12, wherein upon confirmation that the specific guest is located at the doorway of the guest room, it is determined that the specific guest has entered the guest room.

14. The method of claim 12, further comprising:
confirming whether the guest is located in the handover zone area, upon determination that the specific guest is not located at the doorway of the guest room.

15. The method of claim 14, further comprising:
searching for a person related to the specific guest in a space connected to the handover zone area; and
comparing the specific guest with the searched person by using a re-identification (Re-ID) algorithm.

16. The method of claim 15, further comprising:
mapping the searched person to the specific guest, upon determination that the specific guest and the searched person are identical or similar to each other.

17. The method of claim 15, wherein upon determination that the specific guest and the searched person are not identical or not similar to each other, it is determined that tracking of the specific guest has failed.

18. The method of claim 10, further comprising:
confirming whether the specific guest is located at the doorway of the guest room by using the second image, upon determination that the specific guest is not present in the first image and the specific guest is present in the second image.

19. The method of claim 18, wherein upon determination that the specific guest is located at the doorway of the guest room, it is determined that the specific guest has left the guest room.

20. The method of claim 18, further comprising:
confirming whether the specific guest is located in the handover zone area, upon determination that the specific guest is not located at the doorway of the guest room.

21. The method of claim 20, wherein upon determination that the specific guest is located in the handover zone area, it is determined that the specific guest moves to a space connected to the handover zone area.

22. A server for monitoring a guest usage status through at least one camera, the server comprising:
a wireless communicator for transmitting and receiving wireless signals;
a memory; and
a controller functionally connected the wireless communicator and the memory,
wherein the controller performs check-in for a customer scheduled to stay, based on vehicle license plate information acquired by a first camera, confirms types of guests entering a guest room by using guest information of the guest which is acquired by a second camera and a re-identification (Re-ID) of the guest by a third camera based on the guest information, and controls cameras to track a movement path of the guest by using image information of the guest coming out of the guest room which is acquired by the third camera and the re-identification of the guest which is acquired by a fourth camera, based on the image information of the guest.

23. A method for tracking a person by using a camera, the method comprising:
capturing a first image with the camera;
determining whether a first person on which the tracking is to be performed is present in the first image;
finding a second image corresponding to a previous image of the first image;
determining whether the first person is present in the second image;
determining a location of the first person by confirming whether the first person is present in the second image;
determining a second person to be identical to the first person based on the determined location; and
updating location information of the determined second person and performing the tracking on the second person.

24. The method of claim 23, wherein the location includes a handover zone area that indicates a doorway of a specific location or an area connected to another space.

25. The method of claim 24, wherein the second person enters a specific place, leaves the specific place, moves to another space, or disappears during the tracking.

26. The method of claim 24, further comprising:
confirming whether the first person is located at the doorway by using the first image, upon determination that the first person is present in the first image and the first person is not present in the second image.

27. The method of claim 26, wherein upon determination that the first person is located at the doorway, the first person enters the specific place.

28. The method of claim 26, further comprising:
confirming whether the first person is located at the handover zone area, upon determination that the first person is not located at the doorway.

29. The method of claim 28, further comprising:
searching for a third person related to the first person in a space connected to the handover zone area; and
comparing the first person and the third person through a re-identification (Re-ID) algorithm.

30. The method of claim 29, further comprising:
mapping the third person to the first person, upon determination that the first person and the third person are identical or similar to each other.

31. The method of claim 29, wherein upon determination that the first person and the third person are not identical or similar to each other, the first person is determined to be identical to the second person, and the second person is determined as being disappeared.

32. The method of claim 25, further comprising:
confirming whether the first person is located at the doorway by using the second image, upon determination that the first person is not present in the first image and the first person is present in the second image.

33. The method of claim 32, wherein upon confirmation that the first person is located at the doorway, the first person leaves the specific place.

34. The method of claim 32, further comprising:
confirming whether the first person is located in the handover zone area, upon determination that the first person is not located at the doorway.

35. The method of claim 34, wherein as the first person is located in the handover zone area, the first person moves to a space connected to the handover zone area.

36. The method of claim 23, further comprising:
transmitting information related to tracking performance of the second person to a server.

37. The method of claim 23, wherein the camera is installed in at least one of a parking lot of a hotel, an entrance of the hotel, a lobby of the hotel, and a corridor of each floor of the hotel, and the person is a guest of the hotel.
